(19) United States
(12) Patent Application Publication
(10) Pub. No.: US 2003/0107550 A1
(43) Pub. Date: Jun. 12, 2003

(54) Display device with at least one pointer instrument arranged in its housing part on the front side

(76) Inventor: Gert-Dieter Tuzar, Obereschach (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/310,070

(22) Filed: Dec. 5, 2002

(30) Foreign Application Priority Data
Dec. 11, 2001 (DE) 101 607 49.0

(51) Int. Cl. G09G 5/00

(52) U.S. Cl. 345/156

(57) ABSTRACT

A display device with at least one pointer instrument which is arranged in its housing part on the front side and has a surface on the front side is proposed, the surface on the front side of the pointer instrument being free from any apertures and formed in one piece together with the housing part on the front side of the display device. The surface on the front side of the pointer instrument may be produced in one piece together with the housing part on the front side of the display device from plastic in a 2-component injection-molding process.

### CROSS REFERENCE TO RELATED APPLICATIONS

The present application claims priority to German patent application DE 10160749.0, filed Dec. 11, 2001, which is incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The invention relates to a display device with at least one pointer instrument which is arranged in its housing part on the front side and has a surface on the front side. The preferred application of the display device is in an instrument cluster of a vehicle.

An instrument cluster is a subassembly which is fitted in the dashboard of a vehicle and has in its housing part on the front side not only indicator lights and other displays for warning or informing their driver but also at least one pointer instrument. Commercially available instrument clusters have on their housing part on the front side, for the pointer instrument, a pointer with a spindle which penetrates the surface on the front side of the pointer instrument and sweeps over a dial to indicate a measured value. The surface on the front side of the pointer instrument is consequently formed substantially by the dial covering the pointer instrument. For protection from contact, dirt and ingress of moisture, instrument clusters of this type are covered on the front side at a certain distance from the dial by a cover plate made of plastic or mineral glass. However, this arrangement has the disadvantage that, when light falls on it, a cover plate unavoidably causes disturbing reflexes and reflections. This effect is particularly pronounced in the case of vehicles in which the instrument cluster is usually not protected from disturbing incidence of light, for example by a shroud, that is in particular in the case of commercial vehicles, motorcycles, construction machines and open-top vehicles. In the case of most of these vehicles mentioned, there is not the space available that is necessary to provide an enclosure providing protection from undesired incidence of light as a shield for the instrument cluster in the dashboard.

To reduce the disturbing reflexes and reflections, display areas in the display device have been shaded by mechanical design measures, for example by arranging the pointer instrument in a tube set into the display device or shielding it from incidence of light by a drawn-forward bead or shroud. The cover plate has also been arranged in a curved manner above a dark, reflex-free area, in order to direct the optical path of rays against this area. All these measures either cannot be taken for reasons of lack of space, or can only be taken very incompletely, in the preferred application described. Anti-reflex coatings or the provision of specific, sometimes quite complex, structures have also already been proposed for the configuration of the surface of the cover plate, but make a cover plate unacceptably expensive due to the effort which is required. Moreover, the provision of optical structures on the cover plate is accompanied by a certain lack of sharpness of the reading quality of the pointer instruments and displays arranged behind this cover plate.

### BRIEF SUMMARY OF THE INVENTION

It is consequently the object of the present invention to present a display device with at least one pointer instrument which is arranged in its housing part on the front side and has a surface on the front side, the surface of the pointer instrument being reflex-free and not having any disturbing reflections with respect to the viewer when light falls on it, and consequently is also suitable for use in the preferred application.

The object is achieved by a display device for displaying a value from a display front, comprising: at least one pointer for indicating said value; and a housing part accommodating said at least one pointer therein and comprising a front surface defining a portion of said display front such that said at least one pointer is positioned behind said front surface, said front surface having no apertures and defining together with said housing part a single piece.

A display device of this type with at least one pointer instrument which is arranged in its housing part on the front side and has a surface on the front side is distinguished by the fact that the surface on the front side of the pointer instrument is free from any apertures and is formed in one piece together with the housing part on the front side of the display device. For instance, it is advantageous to produce the surface on the front side of the pointer instrument in one piece together with the housing part on the front side of the display device from plastic in a 2-component injection-molding process. The scale and the markings for its inscription can also be produced in the 2-component injection-molding process.

One embodiment of the invention provides that the housing part on the front side of the display device has an at least partially transparent covering to allow a deflectable discrete pointer or a display zone arranged behind it to be seen, the pointer function being graphically reproduced on the display zone by an electronic control circuit. A further embodiment of the invention provides that the housing part on the front side of the display device is produced completely from a translucent plastic, an at least partially transparent covering being incorporated with positive engagement in this housing part on the front side to allow a deflectable discrete pointer or a display zone arranged behind it to be seen, the pointer function being graphically reproduced on the display zone. In this case, the housing part on the front side, produced completely from a translucent plastic, of the display device may be coated with an opaque lacquer film, the regions for the scale and the markings for its inscription being removed from this lacquer film, so that regions and markings cut out from the lacquer film can be illuminated by lighting means arranged in the interior of the display device. In the case of both aforementioned configurations of the invention, webs which channel the stream of light from lighting means fitted in the interior of the display device may be formed internally on the housing part on the front side of the display device or on the surface on the front side of the pointer instrument, in many cases the scale and the markings for its inscription being illuminated in different colors. These lighting means and the drive for the pointer or the display may advantageously be mounted on the same printed circuit board. Similarly, the display device is closed off on the rear side by a housing cover or by the aforementioned, correspondingly shaped printed circuit board.

The solution found has the particular advantage that it creates a display device without a cover plate, without any losses in functionality. By dispensing with the cover plate, not only is a component saved, which leads to a significant reduction in costs in the case of a display device of the generic type, but it also eliminates entirely the cause of disturbing reflections and reflexes. Sharpness and contrast of the analog and digital displays arranged in the display device are not impaired by optical measures. The fact that the surface on the front side of the pointer instrument is free from any apertures and is formed in one piece together with the housing part on the front side of the display device allows neither dust nor dirt nor moisture to penetrate into the display device from the front side. Similarly, protection against contact with moving parts is not required, because no turning pointer is arranged on the front side of the display device. The proposed configuration of a display device is very robust with respect to mechanical vibrations, which makes this configuration suitable for use in the preferred application. With the proposed display device, an instrument cluster can be formed as a very compact, flat subassembly, because this configuration does not require a large overall depth. For example, the distance between the surface on the front side of the display instrument and the cover plate that is otherwise necessary for the space in which the pointer can move is no longer needed.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 shows an exemplary embodiment of the invention in the form of a display device with a discrete pointer instrument in a housing produced in the 2-component injection-molding process,

FIG. 2 shows an exemplary embodiment of the invention in the form of a display device with a pointer instrument reproduced on a display in a housing produced in the 2-component injection-molding process,

FIG. 3 shows an exemplary embodiment of the invention in the form of a display device with a discrete pointer instrument in a housing in an abratively worked housing,

FIG. 4 shows an exemplary embodiment of the invention in the form of a display device with a pointer instrument reproduced on a display in an abratively worked housing and

FIG. 5 shows a display device of a conventional type of construction.

### DETAILED DESCRIPTION OF THE INVENTION

For better understanding of the invention, the explanation of FIG. 5 is presented first here. FIG. 5 shows a conventionally constructed display device with a housing 1, the housing part 12 of which on the front side encloses a transparent cover plate 2. The housing 1 is usually closed off on the rear side by a housing cover 3. Under the cover plate 2 there is in the interior of housing 1, at a distance d1 offset into the housing 1, a dial 5 with a scale depicted on it, a pointer 4 of a pointer instrument sweeping over the dial 5 for the purpose of indicating a measured value and the scale usually being printed on the dial 5. Consequently, the dial 5 substantially forms the surface 11 on the front side of the pointer instrument. On the other hand, on account of its arrangement at the distance d1 from the dial 5, the cover plate 2 is to be considered as belonging to the housing part 12 on the front side of the display device. The pointer 4 is generally attached rigidly to a spindle 6 penetrating the dial 5. The spindle 6 is, for its part, driven for example by a stepping motor or some other suitable drive 7. Accordingly, the pointer instrument substantially comprises the pointer 4, the spindle 6, the drive 7 and a scale. The scale and, if appropriate, the inscription on the dial 5 are usually illuminated when there are inadequate light conditions to make them easier to read.

In this example, back lighting is shown, for which reason lighting means 8, which for example comprise light-emitting diodes and are mounted on an electrical printed circuit board 9, are provided in the interior of the display device, behind the dial 5. In this case, the space indicated in FIG. 5 with the height d2 forms a light box 10, which serves for positioning the lighting means 8 and channeling the stream of light produced by them. All in all, a display device of the conventional type of construction requires a relatively great overall height owing to its constructional design.

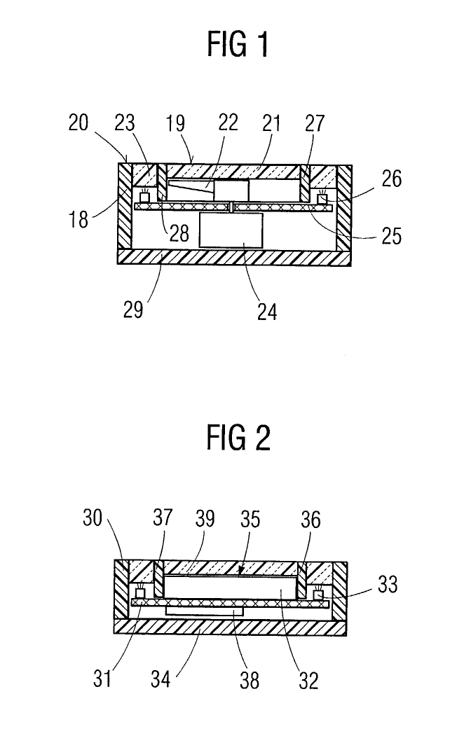

FIG. 1 then shows an exemplary embodiment of the invention in the form of a display device in a housing 18 produced from plastic in a 2-component injection-molding process, with a discretely constructed pointer instrument. In this example, at least the display front or surface 19 on the front side of the pointer instrument is free from any apertures and is formed in one piece together with the housing part 20 on the front side of the display device. In this case, the housing part 20 on the front side of the display device has an at least partially transparent covering 21 for a deflectable pointer 22 arranged behind it. In connection with the surface 19 on the front side of the pointer instrument, a scale and, if appropriate, an inscription 23 are preferably likewise formed in the 2-component injection-molding process. The scale and, if appropriate, its inscription 23 are consequently located directly and without any offset in the same plane with the surface 19 on the front side of the pointer instrument, the surface 19 on the front side of the pointer instrument, for its part, being formed in one piece together with the housing part 20 on the front side of the display device. Accordingly, in the production process, the housing part 20 on the front side of the display device and the covering 21 and also, if appropriate, a scale and the markings for its inscription 23 can be produced in a single injection mold, by the covering 21 and, if appropriate, the scale and the markings for its inscription 23 being encapsulated by the material required for the housing part 20 on the front side of the display device. Consequently, a transparent plastics material is preferably chosen for the covering 21 and at least a light-conducting plastics material is chosen for the region of the scale and the markings for its inscription 23, whereas an opaque plastic is more likely used for the housing part 20 on the front side of the display device. As stated in the explanation relating to FIG. 5, the pointer 22 may be driven by a drive or drive means 24, formed for example as a stepping motor, it being possible to mount the drive 24 on an electrical printed circuit board 25 and to make the pointer 22 rotate directly above the printed circuit board 25, but directly on the rear side of the covering 21. Lighting means 26, which emit their light in the direction of the scale and its inscription 23, can, in turn, also be mounted on the printed circuit board 25. It is advantageous to form webs 27, 28 which channel the stream of light of the lighting means 26 and help to avoid undesired overlaying of differently illuminated regions internally on the housing part 20 on the front side of the display device or on the surface 19 on the front side of the pointer instrument. The housing 18 of the display device is generally closed off on the rear side by a base housing cover 29, but under some circumstances the correspondingly shaped printed circuit board 25 could also be used as the rear wall. An important aspect of the solution found is the one-piece configuration which is free from any apertures of the housing part 20 on the front side of the display device, at least in connection with a covering 20 for the pointer 22 and also for the region of the scale and its inscription 23.

FIG. 2 represents a further exemplary embodiment of the invention. Here, too, the display device comprises a housing 30 which is produced in the 2-component injection-molding process and in the case of which at least the surface on the front side of the pointer instrument is free from any apertures and formed in one piece together with the housing part on the front side of the display device in the way described above in conjunction with FIG. 1. The difference from FIG. 1 is that on the printed circuit board 31 there is mounted, for example, an LC display 32, on the display means or zone 35 of which the pointer function is graphically reproduced by a corresponding electronic control circuit 38, it being possible for a viewer to see the display zone 35 through an at least partially transparent covering 39, which is formed with positive engagement in the housing part 30 on the front side of the display device in the way described above. The display can consequently be read unhindered. In this exemplary embodiment, too, lighting means 33, webs 36, 37 shielding the stream of light and a housing cover 34 closing off the housing 30 can again be provided as required.

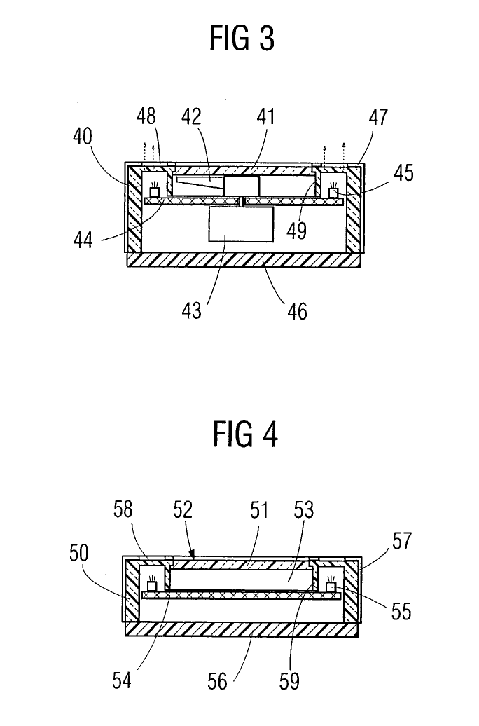

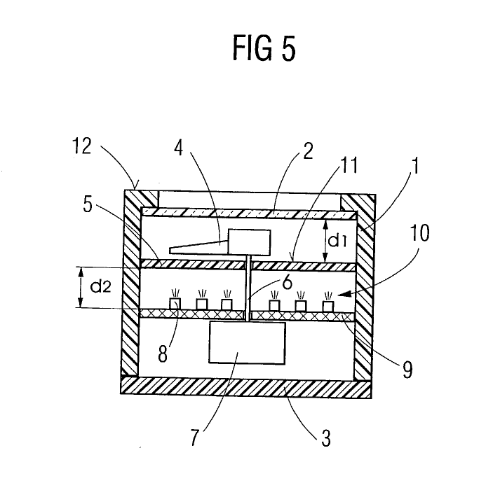

In the configurations of the display device according to FIGS. 3 and 4, it is proposed to produce at least the housing part 40 or 50 on the front side of the display device completely from a translucent plastic, an at least partially transparent covering 41 or 51 being incorporated with positive engagement in this housing part 40 or 50 on the front side for a conventional pointer 42 arranged behind said covering or for a pointer function produced in virtual form on a display zone 52 of a display 53. The other functional elements, such as a stepping motor 43 for driving a conventional pointer 42, a printed circuit board 44 or 54, an electronic control circuit 60 for activating the display 53, lighting means 45 or 55 or a housing cover 46 or 56 may be present in the way described above. In the case of these configurations of the proposed display device according to FIGS. 3 and 4, the housing part 40 or 50 on the front side, produced from a translucent plastic, is coated with an opaque lacquer film 47 or 57, from which the scale and, if appropriate, the markings for its inscription 48 or 58 are removed, for example by means of a laser, so that at these points the covering lacquer film 47 or 57 is cut out from the translucent plastic of the housing part 40 or 50 on the front side. In the switched-on state of the lighting means 45 or 55 arranged in the interior of the display device, the scale and the markings for its inscription 48 or 58 then appear illuminated, because the housing part 40 or 50 on the front side, produced from a translucent plastic, acts as a light guide. This housing part 40 or 50 on the front side, which has been worked by means of a laser, can be provided in a simple way with different scales and inscriptions, because the program for controlling a laser can easily be altered. There is no longer any need for keeping many variants of printed dials in stock.

In all the configurations represented of the solution found according to FIGS. 1 to 4, the scale and its inscription may also be presented in color by suitable choice of the lighting means 26, 33, 45 or 55, it also being readily possible to create regions or markings illuminated in different colors by the forming of light enclosures by means of the webs 27, 28, 36, 37, 49 or 59 formed on the surface on the front side of the pointer instrument or on the housing part on the front side.

In all the exemplary embodiments presented, it can be seen that the solution found allows a display device of the generic type to be made in a previously unachieved flat type of construction, reflexes and disturbing reflections when light falls on it not being able to occur in the first place because of the elimination of a cover plate arranged at a distance from the dial. The proposed solution also makes display devices of the generic type less costly, because there is no longer any need for a cover plate, possibly laboriously provided with an anti-reflective coating, and a printed dial as a component for the display device. The proposed display device offers the viewer a robust, easy-care, closed surface on which the display function is provided directly and without any offset in the overall depth.

The invention being thus described, it will be obvious that the same may be varied in many ways. Such variations may include a mixing of elements from the above embodiments. Such variations are not to be regarded as a departure from the spirit and scope of the invention, and all such modifications as would be obvious to one skilled in the art are intended to be included within the scope of the following claims.

I claim:

1. A display device for displaying a value from a display front, comprising:
at least one pointer for indicating said value; and
a housing part accommodating said at least one pointer therein and comprising a front surface defining a portion of said display front such that said at least one pointer is positioned behind said front surface, said front surface having no apertures and defining together with said housing part a single piece.

2. The device according to claim 1, wherein said display front surface further comprises a scale and markings.

3. The device according to claim 1, further comprising:
a display zone positioned behind said front surface and within said display device, said display zone comprising display means for graphically depicting said at least one pointer; and
at least a partially transparent cover covering said front surface facilitating viewing of said at least one pointer through said front surface.

4. The device according to claim 2, further comprising:
a display zone positioned behind said front surface and within said display device, said display zone comprising display means for graphically depicting said at least one pointer; and
at least a partially transparent cover covering said front surface facilitating viewing of said at least one pointer through said front surface.

5. The device according to claim 1, further comprising:
a display zone positioned behind said front surface and within said display device, said display zone accommodating said at least one pointer; and
at least a partially transparent cover covering said front surface facilitating viewing of said at least one pointer through said front surface.

6. The device according to claim 2, further comprising:
a display zone positioned behind said front surface and within said display device, said display zone accommodating said at least one pointer; and
at least a partially transparent cover covering said front surface facilitating viewing of said at least one pointer through said front surface.

7. The device according to claim 2, further comprising:
an opaque lacquer film covering said display front except for said scale and markings; and
lighting means positioned behind said display front, said lighting means illuminating at least said scale and markings.

8. The device according to claim 3, further comprising:
an opaque lacquer film covering said display front except for said scale and markings; and
lighting means positioned behind said display front, said lighting means illuminating at least said scale and markings.

9. The device according to claim 5, further comprising:
an opaque lacquer film covering said display front except for said scale and markings; and
lighting means positioned behind said display front, said lighting means illuminating at least said scale and markings.

10. The display device according to claim 1, further comprising:
lighting means positioned behind said display front, said lighting means illuminating said front surface; and
at least one web positioned between said lighting means and said at least one pointer, said web directing light from said lighting means to said display front and away from said at least one pointer.

11. The display device according to claim 3, further comprising:
lighting means positioned behind said display front, said lighting means illuminating said display front; and
at least one web positioned between said lighting means and said at least one pointer, said web directing light from said lighting means to said display front and away from said at least one pointer.

12. The display device according to claim 5, further comprising:
lighting means positioned behind said display front, said lighting means illuminating said display front; and
at least one web positioned between said lighting means and said at least one pointer, said web directing light from said lighting means to said display front and away from said at least one pointer.

13. The display device according to claim 8, further comprising:
lighting means positioned behind said display front, said lighting means illuminating said display front; and
at least one web positioned between said lighting means and said at least one pointer, said web directing light from said lighting means to said display front and away from said at least one pointer.

14. The display device according to claim 11, wherein said at least one web is formed on said front surface.

15. The display device according to claim 1, further comprising pointer drive means, positioned within said housing part and on said printed circuit board, said pointer drive means connected to said at least one pointer so as to drive said at least one pointer.

16. The display device according to claim 1, further comprising a base housing cover running along a bottom of said display device, said base housing cover closing off an interior of said display device.

17. The device according to claim 16, wherein said base housing cover comprises a printed circuit board.

18. The display device according to claim 8, wherein said scale and markings are illuminated in different colors.

19. The device according to claim 1, wherein said front surface comprising plastic from a 2-component injection molding process.

20. The device according to claim 19, wherein said plastic is translucent.
